(19) United States
(12) Patent Application Publication
(10) Pub. No.: US 2018/0209208 A1
(43) Pub. Date: Jul. 26, 2018

(54) ADJUSTABLE PLANTATION SHUTTERS

(71) Applicant: Howard Dawson, Cape Coral, FL (US)

(72) Inventor: Howard Dawson, Cape Coral, FL (US)

(21) Appl. No.: 15/873,745

(22) Filed: Jan. 17, 2018

Related U.S. Application Data
(60) Provisional application No. 62/449,482, filed on Jan. 23, 2017.

(51) Int. Cl. E06B 7/092; E06B 9/38

(52) U.S. Cl. CPC E06B 7/092; E06B 2009/2488; E06B 9/38

(57) ABSTRACT

Adjustable plantation shutters and methods for forming and installing the same. A shutter includes a frame that includes a base portion with a hub and an arch portion coupled to the base portion. The shutter further includes a plurality of louvers extending from the hub toward the arch portion, each louver including a pivot axis. The shutter is configured to selectively transition between a closed orientation and an open orientation by rotating each louver about the pivot axis. In some embodiments, each louver is operatively coupled to the arch portion via a magnetic coupling. In some embodiments, each louver is coupled to the hub via a corresponding drive pin, and the shutter further includes a drive mechanism operatively coupled to each louver to pivot each louver about the respective pivot axis.

### RELATED APPLICATION

This application claims priority under 35 U.S.C. § 119(e) to U.S. Provisional Patent Application Ser. No. 62/449,482, which was filed on Jan. 23, 2017, and the complete disclosure of which is hereby incorporated by reference.

### FIELD

The present disclosure relates generally to the field of shutters, and more particularly to the field of plantation window shutters and methods for forming and installing the same.

### BACKGROUND

Plantation shutters are louvered shutters in which the louvers are pivotal relative to the frame of the shutters to enable a user to control the amount of light and/or airflow that passes through the shutters. Plantation shutters may include louvers that do not extend along parallel pivot axes but may be adjusted as a unit due to mechanical and/or motorized linkages that interconnect the louvers.

Many traditional plantation shutters include a rectangular frame that defines a central passage in which a plurality of louvers, or “slats,” is pivotally mounted. Specifically, each louver includes a longitudinal axis that extends into opposed sidewalls of the shutter's frame to enable pivotal movement of the louver relative to the frame. In such a construction, all of the louvers extend parallel to each other and all pivot about parallel axes. With many such conventional louvered shutters, an adjustment rod also interconnects the plurality of louvers so that forces imparted to the rod (transverse to the longitudinal axes of the louvers) will cause synchronized pivoting of all of the louvers relative to the frame when the user moves the rod.

However, some windows do not have rectangular openings, and some consumers may want plantation shutters that do not have (or permit) parallel louvers. Conventionally, if there is a desire to produce plantation shutters having a geometry in which the louvers do not extend parallel to each other, then the louvers, frame, and adjustment rod typically must be custom designed, sized, and manufactured. As a result, such plantation shutters with non-parallel louvers tend to be more time-consuming and expensive to produce than plantation shutters with parallel louvers. Additionally, such plantation shutters with non-parallel louvers may be awkward or difficult to operate with an adjustment rod that must translate and rotate through three dimensions to actuate the plurality of louvers.

### SUMMARY

Adjustable plantation shutters are disclosed herein. An adjustable plantation shutter includes a frame that includes a base portion with a hub and an arch portion coupled to the base portion such that the base portion and the arch portion define a shutter plane. The shutter further includes a plurality of louvers extending from the hub toward the arch portion, each louver including a wide louver side that is proximal the arch portion relative to the hub, a hub louver side that is proximal the hub relative to the arch portion, a longitudinal axis that extends from a center of the wide louver side to a center of the hub louver side, and a pivot axis about which the louver rotates. The shutter is configured to selectively transition between a closed orientation and an open orientation by rotating each louver about the pivot axis. In some embodiments, each louver of the plurality of louvers includes a louver magnetic material, and the arch portion includes a plurality of arch magnetic materials. In such an embodiment, each louver is operatively coupled to the arch portion via a magnetic coupling between a respective louver magnetic material and a corresponding arch magnetic material. In some embodiments, each louver is coupled to the hub via a corresponding drive pin, and the shutter further includes a drive mechanism with a motor operatively coupled to each louver via a corresponding drive pin. In such an embodiment, the drive mechanism is at least substantially enclosed in the hub, and is configured to pivot each louver about the respective pivot axis to actuate the plurality of louvers between the open orientation and the closed orientation. Methods for manufacturing and installing adjustable plantation shutters also are disclosed, and incorporated herein.

### BRIEF DESCRIPTION OF THE DRAWINGS

FIG. 1 is an elevation view illustrating an adjustable plantation shutter according to the present disclosure in a closed orientation.

FIG. 2 is an elevation view illustrating the shutter of FIG. 1 in an open orientation.

FIG. 3 is a schematic elevation view of an adjustable plantation shutter according to the present disclosure.

FIG. 4 is a perspective top view of a shutter louver installed on a hub according to the present disclosure.

FIG. 5 is a perspective top view of a shutter drive pin according to the present disclosure.

FIG. 6 is a perspective bottom view of the drive pin of FIG. 5.

FIG. 7 is a plan view of a shutter chain according to the present disclosure.

FIG. 8 is a perspective bottom view of a shutter drive mechanism according to the present disclosure that includes drive pin grooves.

FIG. 9 is a perspective bottom view of a shutter drive mechanism according to the present disclosure that includes drive pin bushings.

FIG. 10 is a cutaway elevation view of an adjustable plantation shutter according to the present disclosure.

FIG. 11 is an elevation view of a portion of an adjustable plantation shutter according to the present disclosure.

FIG. 12 is a bottom perspective view of an arch portion of a frame of an adjustable plantation shutter according to the present disclosure.

FIG. 13 is an exploded bottom isometric view of a portion of an adjustable plantation shutter frame according to the present disclosure.

FIG. 14 is a fragmentary bottom isometric view of a frame joint according to the present disclosure.

FIG. 15 is a fragmentary exploded top perspective view of a frame joint according to the present disclosure.

FIG. 16 is a bottom perspective view of a shutter louver according to the present disclosure.

FIG. 17 is a top perspective view of the shutter louver of FIG. 16.

FIG. 18 is a side perspective view of an adjustable plantation shutter according to the present disclosure in an open orientation.

FIG. 19 is an elevation view illustrating an adjustable plantation shutter according to the present disclosure with louvers with concave wide louver sides.

FIG. 20 is an elevation view illustrating an adjustable plantation shutter according to the present disclosure with louvers with convex wide louver sides.

### DETAILED DESCRIPTION

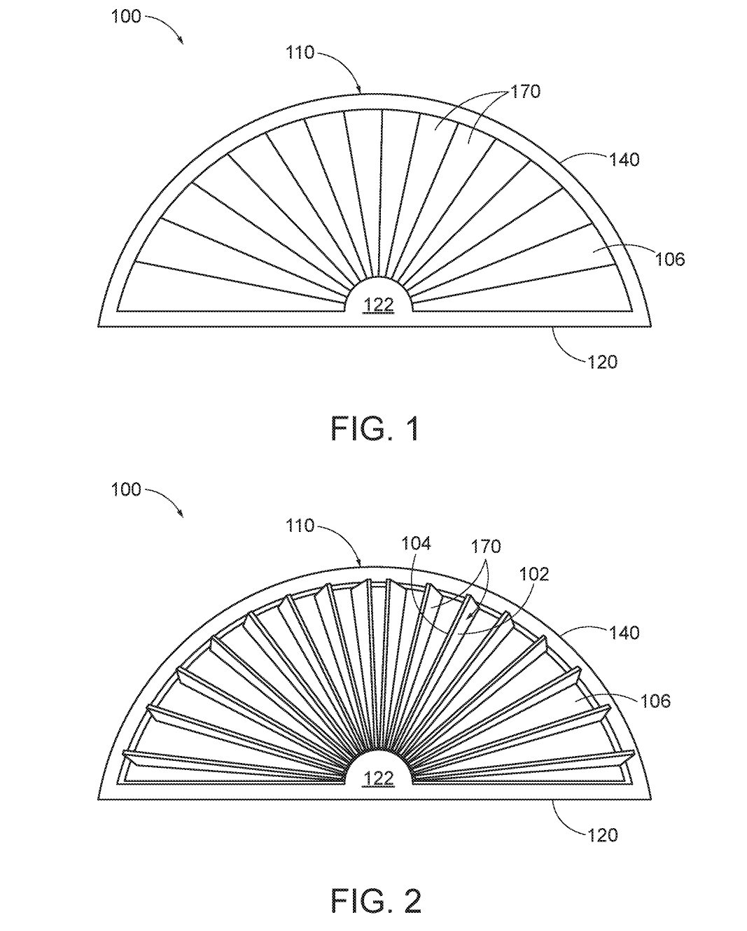

FIGS. 1-20 provide examples of adjustable plantation shutters 100 according to the present disclosure. Elements that serve a similar, or at least substantially similar, purpose are labeled with like numbers in each of FIGS. 1-20, and these elements may not be discussed in detail herein with reference to each of FIGS. 1-20. Similarly, all elements may not be labeled in each of FIGS. 1-20, but reference numbers associated therewith may be utilized herein for consistency. Elements, components, and/or features that are discussed herein with reference to one or more of FIGS. 1-20 may be included in and/or utilized with any of FIGS. 1-20 without departing from the scope of the present disclosure.

In general, elements that are likely to be in a given (i.e., a particular) embodiment are illustrated in solid lines, while elements that are optional to a given embodiment are illustrated in dashed lines. However, elements that are shown in solid lines are not essential to all embodiments, and an element shown in solid lines may be omitted from a given embodiment without departing from the scope of the present disclosure.

As illustrated in FIGS. 1-2, a shutter 100 according to the present disclosure includes a frame 110 that includes a base portion 120 with a hub 122 and an arch portion 140 coupled to the base portion such that the base portion and the arch portion define a shutter plane 106. As used herein, shutter 100 also may be referred to as a plantation shutter 100, an adjustable plantation shutter 100, a window shutter 100, an adjustable window shutter 100, a plantation window shutter 100, an adjustable plantation window shutter 100, and/or a non-rectangular shutter 100. Shutter 100 further includes a plurality of louvers 170 extending from hub 122 toward arch portion 140. As used herein, louver 170 also may be referred to as a slat 170. Shutter 100 is configured to selectively transition between a closed orientation (as illustrated in FIG. 1) and an open orientation (as illustrated in FIG. 2) by rotating each louver 170 with respect to shutter plane 106, such as about a pivot axis of the louver.

Shutter 100 and/or frame 110 may have any appropriate shape. For example, and as illustrated in FIGS. 1-2, frame 110 may have a shape that is semicircular. However, this is not required to all shutters 100, and it is additionally within the scope of the present disclosure that shutter 100 and/or frame 110 may have a shape that is elliptical, oval, circular, quarter-circular, partial circular, triangular, rectangular, wedge-shaped, a polygon, and/or any appropriate combination thereof.

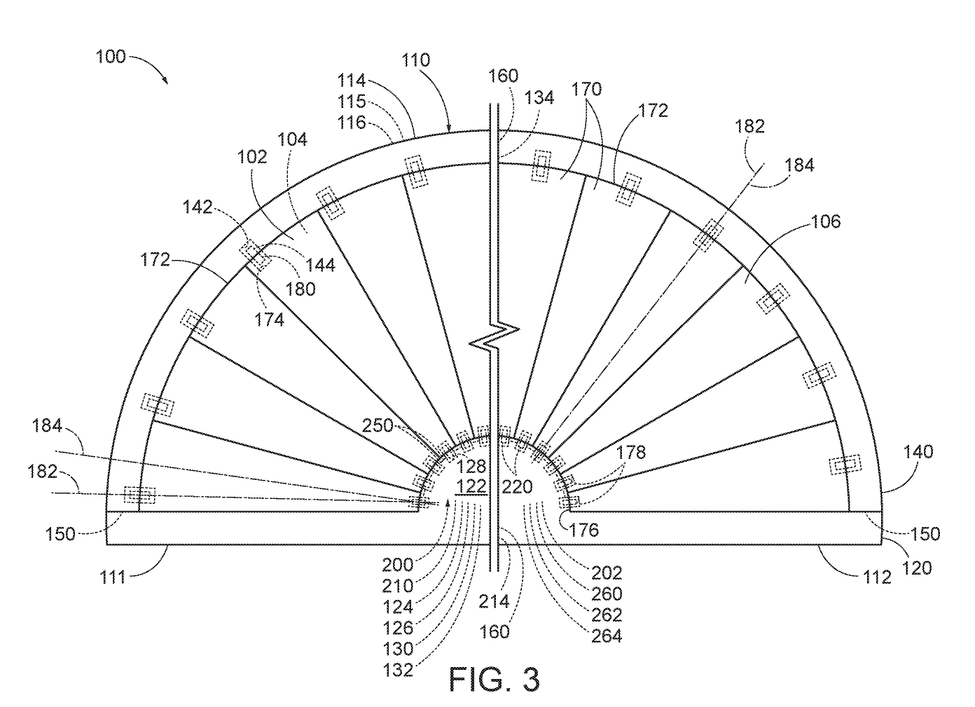

With reference to FIG. 3, each louver 170 includes a wide louver side 172 that is proximal arch portion 140 relative to hub 122 and a hub louver side 176 that is proximal the hub relative to the arch portion. As used herein, wide louver side 172 also may be referred to as an arch louver side 172 and/or a distal louver side 172. As used herein, hub louver side 176 also may be referred to as a narrow louver side 176 and/or a proximal louver side 176. Each louver 170 further includes a longitudinal axis 184 that extends from wide louver side 172 to hub louver side 176 and a pivot axis 182 about which the louver rotates and that also extends from the wide louver side to the hub louver side. Longitudinal axis 184 may have any appropriate orientation relative to louver 170. As examples, longitudinal axis 184 may extend from a center of wide louver side 172 to a center of hub louver side 176, and/or may be an axis of symmetry of the louver. However, this is not required to all louvers 170, and it is additionally within the scope of the present disclosure that longitudinal axis 184 may intersect wide louver side 172 and hub louver side 176 at any appropriate location, such as an edge, a corner, or an off-center point of the wide louver side and/or the hub louver side. As used herein, pivot axis 182 also may be referred to as a rotational axis 182, and/or longitudinal axis 184 also may be referred to as a central axis 184.

Pivot axis 182 may be at least substantially parallel to longitudinal axis 184. For example, and as illustrated in the right-hand side of FIG. 3, pivot axis 182 may be collinear with longitudinal axis 184. As used herein, such an embodiment may be referred to as a collinear axis embodiment. However, this is not required to all shutters 100 according to the present disclosure, and it is within the scope of the present disclosure that pivot axis 182 may be spaced apart from, non-collinear with, and/or angled with respect to longitudinal axis 184. For example, and as illustrated in the left-hand side of FIG. 3, pivot axis 182 may form a nonzero angle with longitudinal axis 184, may intersect the longitudinal axis at exactly one point, may not be parallel to the longitudinal axis, and/or may not intersect the longitudinal axis. As used herein, such an embodiment may be referred to as a non-parallel axis embodiment. Although FIG. 3 includes schematic illustrations of each of the collinear axis embodiment and the non-parallel axis embodiment, a given embodiment of shutter 100 generally will include louvers 170 that embody only the collinear axis embodiment or only the non-parallel axis embodiment.

As indicated in FIGS. 1 and 2, shutter 100 includes a first face 102 and a second face 104 opposite the first face such that each of the first face and the second face is generally parallel to shutter plane 106. In an embodiment in which shutter 100 is installed adjacent a window, the shutter may be oriented such that second face 104 generally faces toward the window and first face 102 generally faces away from the window. However, this configuration is not required, and it is within the scope of the present disclosure that first face 102 and second face 104 have any appropriate spatial relationship with a structure upon which or within which shutter 100 is installed. As used herein, first face 102 and/or second face 104 may refer to respective faces and/or sides of any appropriate component and/or portion of shutter 100. For example, shutter 100 (as a whole) may be said to have first face 102, and each louver 170 also may be said to have a first face that generally faces the same direction as the first face of the shutter when the louver is in the closed orientation.

As schematically illustrated in FIG. 3, frame 110 may have any appropriate construction. For example, in some embodiments, frame 110 includes a left frame side 111 and a separate right frame side 112 such that the left frame side is pivotally coupled to the right frame side by at least one frame hinge 160. Frame hinge 160 may be configured to transition frame 110 between a folded configuration, in which first face 102 of left frame side 111 faces first face 102 of right frame side 112, and an unfolded configuration, in which the left frame side and the right frame side are generally coplanar. For example, the folded configuration enables the shutter to have a smaller, or more compact, configuration, such as which may be useful for storage and/or transport of the shutter. It also is within the scope of the present disclosure that frame hinge 160 additionally or alternatively may be configured to transition frame 110 into a folded configuration in which second face 104 of left frame side 111 faces second face 104 of right frame side 112. It further is within the scope of the present disclosure that frame 110 may not include pivotal left and right frame sides and/or may not include a frame hinge 160.

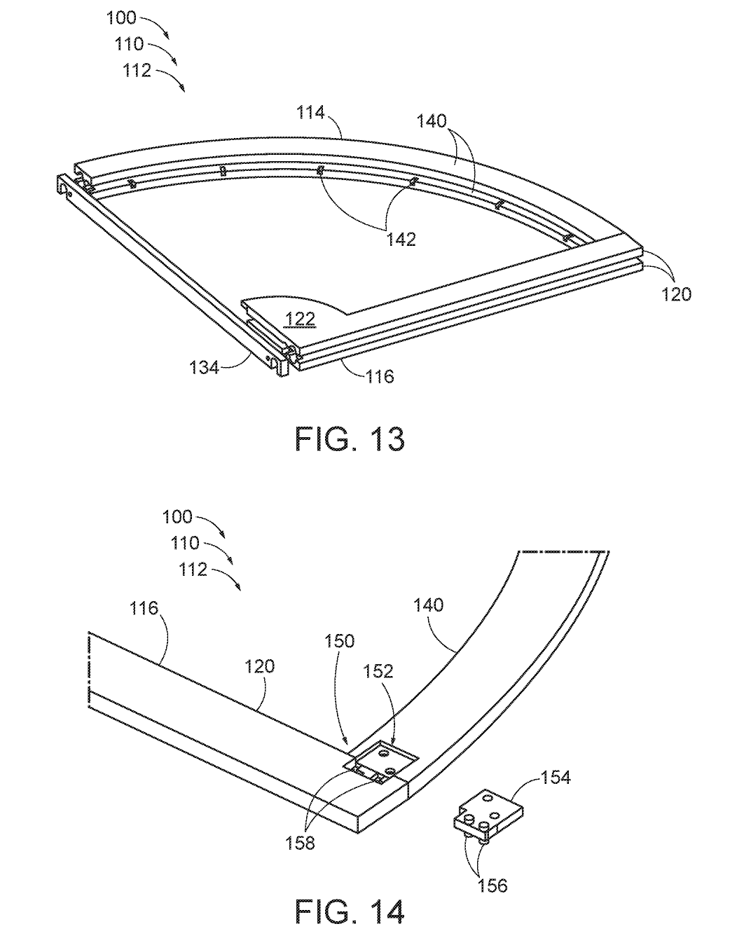

As further schematically illustrated in FIG. 3, and as less schematically illustrated in FIG. 13, shutter 100 also may include a stile 134 configured to extend from base portion 120 to arch portion 140 along a central region of frame 110, such as generally between left frame side 111 and right frame side 112. Stile 134 may be retained in position by one or more stile magnets 132 positioned in frame 110, such as in hub 122 and/or in arch portion 140. It is within the scope of the present disclosure that stile 134, when present, optionally may be retained on the frame by any suitable permanent or releasable fastener.

In some embodiments, frame 110 includes a first frame layer 114 and a second frame layer 116 opposite the first frame layer. Such a frame 110 further may include one, or more than one, central frame layer 115 positioned between the first frame layer and the second frame layer. Each of first frame layer 114, second frame layer 116, and (when present) central frame layer 115 extends generally parallel to shutter plane 106. In such an embodiment, frame 110 also may be referred to as a laminated frame 110 and/or a layered frame 110. First frame layer 114, second frame layer 116, and (when present) central frame layer 115 may be at least substantially identical. For example, first frame layer 114, second frame layer 116, and (when present) central frame layer 115 may be at least substantially identical in size and/or thickness. However, this is not required to all shutters 100, and it also is within the scope of the present disclosure that first frame layer 114, second frame layer 116, and (when present) central frame layer 115 may have different thicknesses and/or different sizes relative to one another.

As further schematically illustrated in FIG. 3, frame 110 may include at least one frame joint 150 configured to selectively couple base portion 120 and arch portion 140 to one another. More specifically, frame 110 and/or frame joint 150 may be configured such that base portion 120 and arch portion 140 may be selectively uncoupled from one another and recoupled to one another without damage to the base portion or the arch portion. However, this is not required to all shutters 100, and it also is within the scope of the present disclosure that frame joint 150 may be configured to join base portion 120 and arch portion 140 permanently and/or semi-permanently.

As used herein, references to portions, components, and/or layers of frame 110 may not refer to a single (i.e., unitary) component, and instead may refer to a subset of a collection of components that constitute the frame. As an example, each of base portion 120 and arch portion 140 may be said to include each of first frame layer 114, second frame layer 116, and (when present) central frame layer 115. Similarly, each of left frame side 111 and right frame side 112 may be said to include each of base portion 120 and arch portion 140.

With continued reference to FIG. 3, each louver 170 may be coupled to arch portion 140 at least partially via an attractive magnetic force. For example, each louver 170 may include a louver magnetic material 180, and arch portion 140 may include a corresponding plurality of arch magnetic materials 144 such that each louver 170 is operatively coupled to arch portion 140 via a magnetic coupling between a respective louver magnetic material and the corresponding arch magnetic material. Such a configuration may yield a more robust and/or stable coupling between louver 170 and arch portion 140 relative to an otherwise identical shutter 100 that includes a mechanical linkage between each louver and the arch portion. For example, a magnetic coupling between louver 170 and arch portion 140 may enable the louver to be magnetically restored to a nominal position relative to the arch portion (e.g., a position in which louver magnetic material 180 is proximal arch magnetic material 144) in the event that the louver is momentarily forced away from this nominal position. Additionally or alternatively, a magnetic coupling between louver 170 and arch portion 140 may enable the louver to be separated from the arch portion without damage to the louver or to the arch portion in the event that the louver receives a force that may otherwise damage a mechanical linkage between the louver and the arch portion.

Louver magnetic material 180 and arch magnetic material 144 may include and/or be any appropriate materials suitable to generate an attractive magnetic force therebetween. As examples, one of louver magnetic material 180 and arch magnetic material 144 may include a magnet, and the other of the louver magnetic material and the arch magnetic material may include a magnet and/or a ferromagnetic material.

Each louver magnetic material 180 may be coupled to the corresponding louver 170 in any suitable manner, such as by being adhered, fastened, frictionally retained, and/or mechanically secured against and/or within the louver. Similarly, each arch magnetic material 144 may be coupled to arch portion 140 by any suitable manner, such as by being adhered, fastened, frictionally retained, and/or mechanically secured against and/or within the arch portion.

As specific examples, each louver magnetic material 180 may be positioned in an arch-side louver bore 174 defined in wide louver side 172 of the corresponding louver 170, and/or each arch magnetic material 144 may be positioned in an arch recess 142 defined in arch portion 140. However, this is not required to all shutters 100, and it also is within the scope of the present disclosure that each louver 170 may be operatively coupled to arch portion 140 at least partially via a mechanical coupling.

FIG. 3 schematically illustrates each louver magnetic material 180 as being spaced apart from a boundary of a corresponding arch-side louver bore 174. However, this is not required to all shutters 100, and it is additionally within the scope of the present disclosure that each louver magnetic material 180 may at least substantially fill the corresponding arch-side louver bore 174 and/or may contact the boundary of the arch-side louver bore. Similarly, FIG. 3 schematically illustrates each arch magnetic material 144 as being spaced apart from a boundary of a corresponding arch recess 142. However, this is not required to all shutters 100, and it is additionally within the scope of the present disclosure that each arch magnetic material 144 may at least substantially fill the corresponding arch recess 142 and/or may contact the boundary of the arch recess.

Louver 170 may be configured such that louver magnetic material 180 and arch magnetic material 144 are in physical contact when the louver is installed in frame 110, and/or such that wide louver side 172 is in physical contact with arch portion 140 when the louver is installed in the frame. However, this is not required to all shutters 100, and it also is within the scope of the present disclosure that wide louver side 172 may be spaced apart from arch portion 140 and/or louver magnetic material 180 may be spaced apart from arch magnetic material 144 when the louver is installed in the frame. In such an embodiment, the attractive magnetic force between lover magnetic material 180 and arch magnetic material 144 retains the louver in its installed operative position despite the magnetic materials not being in physical contact with each other.

Louver magnetic material 180 and arch magnetic material 144 may be configured such that the louver magnetic material does not rotate with respect to louver 170 and the arch magnetic material does not rotate with respect to arch recess 142 when the louver rotates with respect to frame 110. Stated differently, shutter 100 may be configured such that louver magnetic material 180 rotates with respect to arch magnetic material 144 when louver 170 rotates with respect to frame 110.

As schematically illustrated in FIG. 3, shutter 100 may include at least one drive mechanism 200 at least substantially enclosed in hub 122 and configured to actuate the plurality of louvers 170 between the open orientation and the closed orientation. Specifically, drive mechanism 200 may include a motor 210 operatively coupled to each louver 170 via at least one chain 250 that engages a plurality of drive pins 220 to pivot each louver about the respective pivot axis 182. Motor 210 may be any appropriate motor capable of producing a rotary output for pivoting the plurality of louvers 170. As an example, motor 210 may operate at any appropriate voltage and/or amperage, an example of which includes 9 Volts and 0.5 Amperes. Motors that have greater or lower voltages and/or amperages also are within the scope of the present disclosure, as are drive mechanisms 200 that include more than one motor 210, more than one chain 250, and/or one or more other linkages in addition to and/or in place of chain 250. Also within the scope of the present disclosure are drive mechanisms that are manually operated by a user (i.e., non-motorized) and/or shutters that do not include a drive mechanism 200.

When drive mechanism 200 includes at least one motor 210, drive mechanism 200 further may include a motor controller 260 configured to at least partially control a rotary output of motor 210 and/or a motor switch 262 configured to be actuated by a user to at least partially selectively control the rotary output of the motor. Motor controller 260 may include any appropriate components for controlling a rotary output of motor 210, examples of which may include a timer module and a wireless transceiver. Motor switch 262 may be configured to operate in conjunction with motor controller 260 to selectively control the rotary output of motor 210.

When drive mechanism 200 includes at least one motor 210, drive mechanism 200 further may include a motor power supply 264 configured to supply electric power to motor 210. Motor power supply 264 may include and/or be a motor battery, a solar powered motor battery, a solar panel, a photodetector, a motor power adapter, a motor power cord, and/or a motor power cord socket. For example, motor power supply 264 may include the solar panel and the solar powered motor battery such that the solar powered motor battery receives electrical charge from the solar panel and supplies electric power to motor 210. Additionally or alternatively, in an embodiment in which motor power supply 264 further includes the photodetector, the motor power supply may be configured to supply electric power to motor 210 when the photodetector senses a light level that is less than a threshold light level and/or greater than a threshold light level. Hence, the photodetector may permit drive mechanism 200 to operate at least partially automatically responsive to an ambient light level. Similarly, in an embodiment in which motor controller 260 includes the timer module, drive mechanism 200 may be configured such that motor switch 262 supplies electric power to motor 210 to pivot each louver 170 following a predetermined interval of time.

Hub 122 may include a motor compartment 124 configured to enclose motor 210 and/or an electronics compartment 126 configured to enclose electronics associated with drive mechanism 200. As examples, electronics compartment 126 may be configured to enclose motor controller 260, motor switch 262, and/or motor power supply 264. Motor compartment 124 and/or electronics compartment 126 may be defined in any appropriate portion of hub 122. As examples, motor compartment 124 and/or electronics compartment 126 may be defined in one or more of first frame layer 114, second frame layer 116, and (when present) central frame layer 115. As a more specific example, in an embodiment in which frame 110 includes first frame layer 114 and second frame layer 116 but not central frame layer 115, motor compartment 124 and/or electronics compartment 126 may be defined in each of the first frame layer and the second frame layer, such that the motor compartment and/or the electronics compartment extends from the first frame layer to the second frame layer. Motor compartment 124 and electronics compartment 126 may be substantially distinct compartments, may be connected to one another, and/or may refer to respective portions of a single compartment.

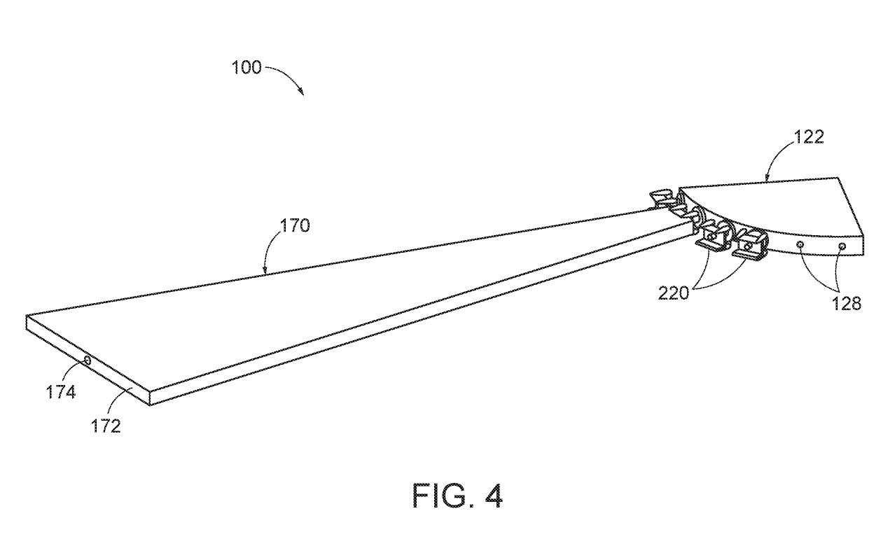

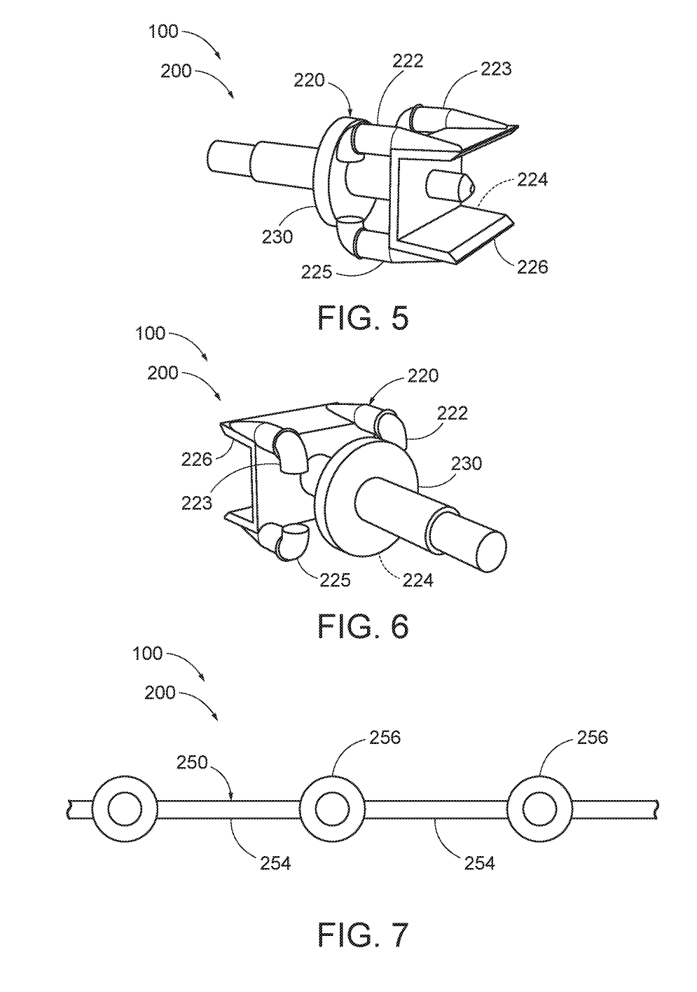

As schematically illustrated in FIG. 3 and as less schematically illustrated in FIG. 4, each louver 170 may be coupled to hub 122 via a corresponding drive pin 220 configured to impart a rotational force to the louver. Each louver 170 may be coupled to a corresponding drive pin 220 in any appropriate manner. For example, and as schematically illustrated in FIG. 3, each drive pin 220 may be received in a hub-side louver bore 178 defined in hub louver side 176. FIG. 3 schematically illustrates each drive pin 220 as being spaced apart from a boundary of a corresponding hub-side louver bore 178. However, this is not required to all shutters 100, and it is additionally within the scope of the present disclosure that each drive pin 220 may at least substantially fill the corresponding hub-side louver bore 178 and/or may contact the boundary of the hub-side louver bore. Additionally or alternatively, and as illustrated in FIGS. 5-6, drive pin 220 may include a louver engagement cradle 226 configured to engage an exterior surface of louver 170 to transmit a rotary force to the louver.

As schematically illustrated in FIG. 3 and as less schematically illustrated in FIG. 4, hub 122 may include a plurality of pin indentations 128 respectively configured to receive each of the plurality of drive pins 220. Pin indentation 128 may extend in a direction that is at least substantially parallel to pivot axis 182 (not illustrated in FIG. 4) of the corresponding louver 170 and/or may be configured to permit drive pin 220 to rotate about the pivot axis. In this manner, an orientation of pin indentation 128 relative to hub 122 and/or to frame 110 may define an orientation of drive pin 220, and thus an orientation of pivot axis 182, relative to the hub and/or to the frame. FIG. 3 schematically illustrates each drive pin 220 as being spaced apart from a boundary of a corresponding pin indentation 128. However, this is not required to all shutters 100, and it is additionally within the scope of the present disclosure that each drive pin 220 may at least substantially fill the corresponding pin indentation 128 and/or may contact the boundary of the pin indentation.

Pin indentation 128 may be defined in any appropriate portion of hub 122, such as in first frame layer 114, second frame layer 116, and/or (when present) central frame layer 115. As an example, pin indentation 128 may be a pin bore 128 defined in an enclosed region of exactly one of first frame layer 114, second frame layer 116, and (when present) central frame layer 115. Alternatively, pin indentation 128 may be a pin groove 128 defined on an exterior face of one or more of first frame layer 114, second frame layer 116, and (when present) central frame layer 115.

As illustrated in FIGS. 5-6, drive pin 220 may be generally cylindrical, and may include louver engagement cradle 226 configured to engage an exterior surface of louver 170. Drive pin 220 also may include a collar 230 extending circumferentially around the drive pin and configured to engage at least a portion of hub 122, such as an interface and/or opening of pin indentation 128. More specifically, collar 230 may be configured to engage hub 122 to at least partially restrict motion of drive pin 220 with respect to the hub in a direction generally parallel to pivot axis 182 and/or longitudinal axis 184. However, this is not required to all shutters 100, and it also is within the scope of the present disclosure that drive pin 220 may not include collar 230, and/or that louver engagement cradle 226 may be configured to engage hub 122 to at least partially restrict motion of the drive pin with respect to the hub.

As schematically illustrated in FIG. 3, and as less schematically illustrated in FIG. 7, drive mechanism 200 may include at least one chain 250. As illustrated in FIG. 7, each chain 250 may include a plurality of chain post attachment points 256 separated by a plurality of linkages 254. Each chain post attachment point 256 may be configured to engage a corresponding chain post 222 (as illustrated in FIGS. 5-6) of a corresponding drive pin 220, such that a substantially longitudinal translation of chain 250 may cause the corresponding drive pin to rotate. Thus, chain 250 may serve to couple each of the plurality of drive pins 220 to one another such that the plurality of drive pins rotates substantially in unison when the chain is translated in a substantially longitudinal direction. As used herein, the term “substantially longitudinal direction,” referring to a direction relative to chain 250, is intended to refer to a direction that is generally parallel to each linkage 254 of the chain, and does not necessarily refer to a single direction that characterizes an entirety of the chain. For example, in an embodiment in which chain 250 assumes an arcuate conformation, each linkage 254 of the chain may have a respective longitudinal direction associated therewith, and not all linkages may share a common longitudinal direction. Stated differently, the term “substantially longitudinal direction” may refer to a direction along a path defined by a spatial orientation of chain 250.

As discussed, and as schematically illustrated in FIG. 3, chain 250 may be positioned in and/or move along a non-linear and/or arcuate conformation. Hence, chain 250 may be configured to assume curved and/or bendable conformations. For example, chain 250 may be a flexible chain, a resiliently flexible chain, and/or a non-rigid chain. As more specific examples, each linkage 254 of chain 250 may be flexible, resiliently flexible, and/or non-rigid, and/or each chain post attachment point 256 may be flexibly and/or rotatably coupled to the adjacent linkages.

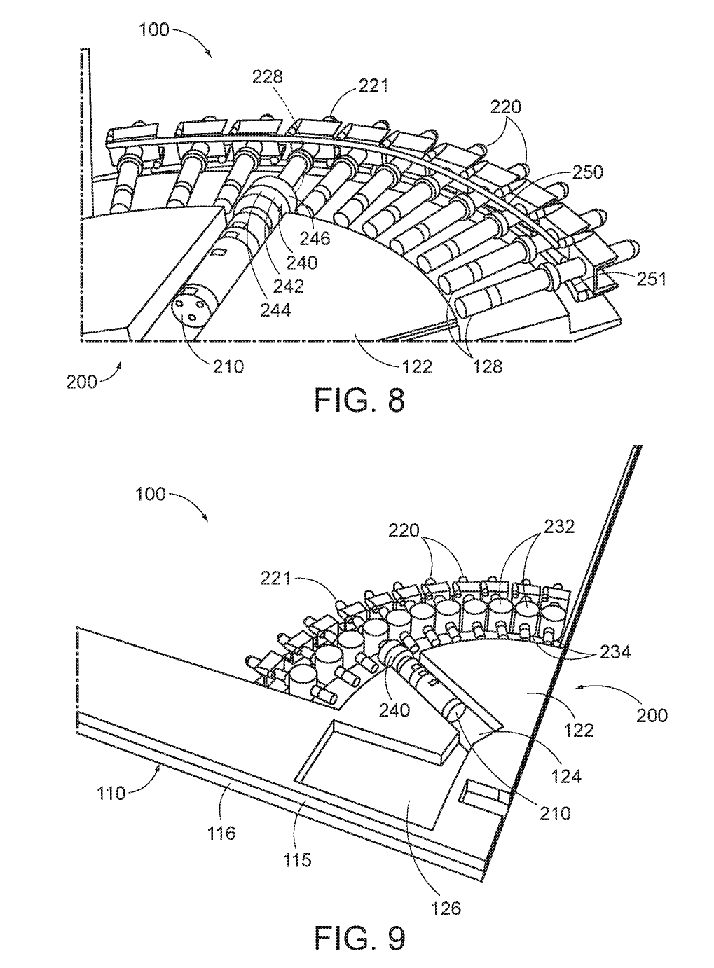

In some embodiments, drive mechanism 200 includes a plurality of chains 250. For example, chain 250 may be a first chain 250, and drive mechanism 200 further may include a second chain 251, such as is shown in FIG. 8. In some embodiments, drive mechanism 200 still further includes at least a third chain and/or a fourth chain, such as with a pair of chains extending from a prime drive pin 221 toward base portion 120 (and interconnecting sequential drive pins in that direction) and a pair of chains extending from prime drive pin 221 in the opposite direction from the first pair of chains (and interconnecting sequential drive pins in that direction). Similarly, drive pin 220 may include a plurality of chain posts 222 such that each chain of the plurality of chains engages each drive pin at a corresponding chain post of the drive pin. For example, and as illustrated in FIGS. 5-6, chain post 222 may be a first chain post 222, and drive pin 220 may further include a second chain post 223, a third chain post 224, and/or a fourth chain post 225. In such an embodiment, each drive pin 220 may be configured to engage first chain 250, second chain 251, a third chain, and a fourth chain at first chain post 222, second chain post 223, third chain post 224, and fourth chain post 225, respectively. However, this is not required to all shutters 100, and it also is within the scope of the present disclosure that each chain 250 may not engage each drive pin 220.

FIG. 8 illustrates an embodiment of shutter 100 in which drive mechanism 200 includes first chain 250 and second chain 251. As illustrated in FIG. 8, the plurality of drive pins 220 may include prime drive pin 221 that is operatively coupled to motor 210 via a motor coupling 240. Prime drive pin 221 may be coupled directly to motor coupling 240, and/or may include a motor engagement structure 228 configured to matingly engage at least a portion of motor coupling 240 to couple the prime drive pin to the motor coupling so that forces from the motor are conveyed to the prime drive pin. Prime drive pin 221 may be operatively coupled to a remainder of the plurality of drive pins 220 via at least one chain 250 of the plurality of chains, such that the prime drive pin may receive a rotary force from motor 210 and relay the rotary force to the remainder of drive pins via the at least one chain. Hence, the plurality of chains 250 may be configured in a pull-pull configuration in which each drive pin 220 receives a tension force on at least one corresponding chain post 222 when motor 210 is operated. Stated differently, drive mechanism 200 may be configured such that the plurality of chains 250 is not configured in either of a push-pull configuration and a push-push configuration. As discussed, it also is within the scope of the present disclosure that other types of mechanical linkages may be used to interconnect the drive pins and/or louvers for collective relative pivoting, examples of which include rods, rigid links, pulls, and/or gears.

Motor coupling 240 may be any appropriate structure configured to transfer a rotational force from motor 210 to prime drive pin 221. For example, and as illustrated in FIG. 8, motor coupling 240 may include a magnetic clutch 242 that includes a motor-side magnetic material 244 and a pin-side magnetic material 246. Magnetic clutch 242 may be configured to transmit an applied torque (such as a torque generated by motor 210) from motor-side magnetic material 244 to pin-side magnetic material 246 at least partially via a magnetic force therebetween when the applied torque is less than a threshold torque. For example, when the applied torque is less than the threshold torque, the magnetic force between motor-side magnetic material 244 and pin-side magnetic material 246 may maintain the motor-side magnetic material and the pin-side magnetic material in physical contact and/or static contact such that the torque may be transmitted via a frictional force. Additionally or alternatively, pin-side magnetic material 246 may be coupled to prime drive pin 221 such that the pin-side magnetic material and the prime drive pin are configured to rotate in unison.

Magnetic clutch 242 further may be configured such that motor-side magnetic material 244 and pin-side magnetic material 246 may rotate with respect to one another when the applied torque is greater than the threshold torque. For example, if one or more louvers 170 are restricted from rotating by an external applied force and/or blockage and motor 210 is operated, magnetic clutch 242 may permit motor-side magnetic material 244 to rotate with respect to pin-side magnetic material 246 while the pin-side magnetic material remains substantially stationary, thereby lowering a risk of damage to the motor. Motor-side magnetic material 244 and pin-side magnetic material 246 may be constructed of any appropriate materials capable of producing a sufficient attractive magnetic force therebetween. For example, one of motor-side magnetic material 244 and pin-side magnetic material 246 may be a magnet, and the other of the motor-side magnetic material and the pin-side magnetic material may be a magnet and/or a ferromagnetic material.

FIG. 9 illustrates an embodiment of shutter 100 in which each drive pin 220 is retained in position with respect to frame 110 via a corresponding drive pin bushing 232. Specifically, in the embodiment of FIG. 9, each drive pin 220 is configured to be received in a corresponding drive pin bushing 232 such that the drive pin bushing is configured to permit the drive pin to rotate therein about the corresponding pivot axis 182. Each drive pin bushing 232 may be statically coupled to hub 122 to substantially define the orientation of the corresponding pivot axis 182 with respect to the hub. For example, each drive pin bushing 232 may be configured to be received in a corresponding bushing retention structure 234 defined in hub 122. FIG. 9 additionally illustrates an embodiment of shutter 100 in which hub 122 includes motor compartment 124 and electronics compartment 126 such that the motor compartment and the electronics compartment are defined in central frame layer 115 and connected to one another.

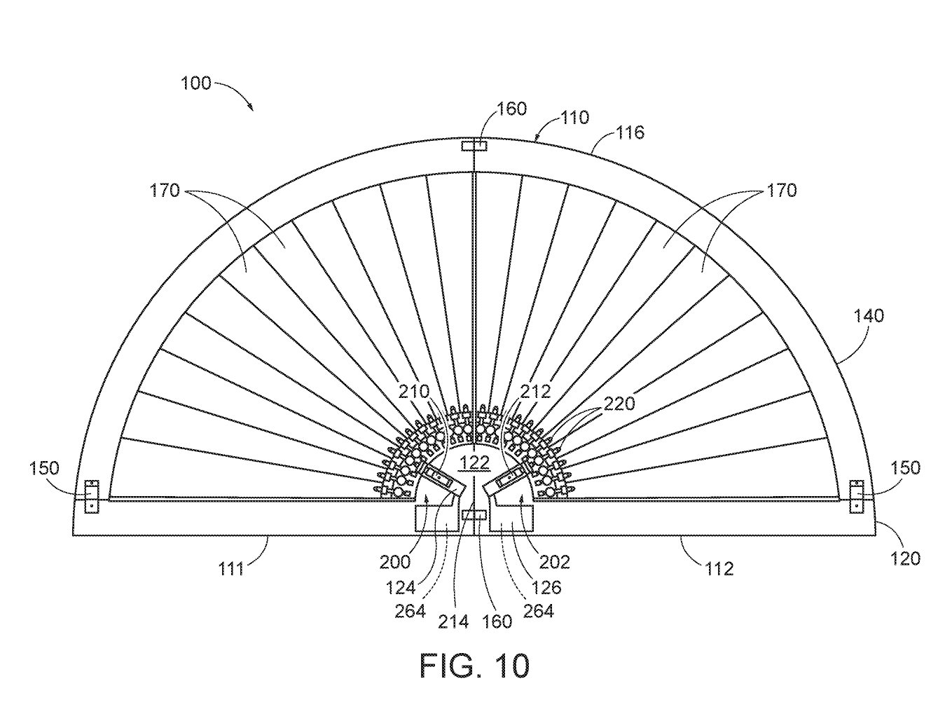

FIG. 10 illustrates an embodiment of shutter 100 that includes left frame side 111 and right frame side 112 coupled by a pair of frame hinges 160. The embodiment of FIG. 10 includes first frame layer 114 and second frame layer 116; however, first frame layer 114 is omitted from FIG. 10 so as to illustrate internal components of shutter 100. As illustrated in FIG. 10, left frame side 111 may include a first plurality of louvers 170, and right frame side 112 may include a distinct second plurality of louvers 170, with each of the first plurality of louvers and the second plurality of louvers being coupled to a respective drive mechanism. Stated differently, drive mechanism 200 may be a first drive mechanism 200 enclosed within hub 122 of left frame side 111, and shutter 100 further may include a second drive mechanism 202 enclosed within hub 122 of right frame side 112, such that the first drive mechanism is configured to actuate the first plurality of louvers between the open orientation and the closed orientation, and the second drive mechanism is configured to actuate the second plurality of louvers between the open orientation and the closed orientation. In such a configuration, motor 210 may be a first motor 210, and second drive mechanism 202 may include a second motor 212. However, this is not required to all shutters 100, and it also is within the scope of the present disclosure that the first plurality of louvers 170 and the second plurality of louvers 170 may be configured to be actuated by a single drive mechanism 200 and/or by a single motor 210.

In an embodiment of shutter 100 that includes first drive mechanism 200 and second drive mechanism 202, first motor 210 and second motor 212 may be configured to actuate the corresponding pluralities of louvers 170 at least substantially in unison. For example, first motor 210 and second motor 212 may be electrically connected to one another via at least one electrical contact 214 such that the first motor and the second motor operate at least substantially in unison. As a more specific example, electrical contact 214 may operatively interconnect left frame side 111 and right frame side 112 such that the electrical interconnect is configured to complete an electrical circuit when frame 110 is in the unfolded configuration and to break the electrical circuit at least when the frame is in the folded configuration. In such a configuration, each of first motor 210 and second motor 212 may receive electrical power from motor power supply 264, which may be at least partially enclosed in electronics compartment 126 defined in hub 122 of left frame side 111 and/or right frame side 112.

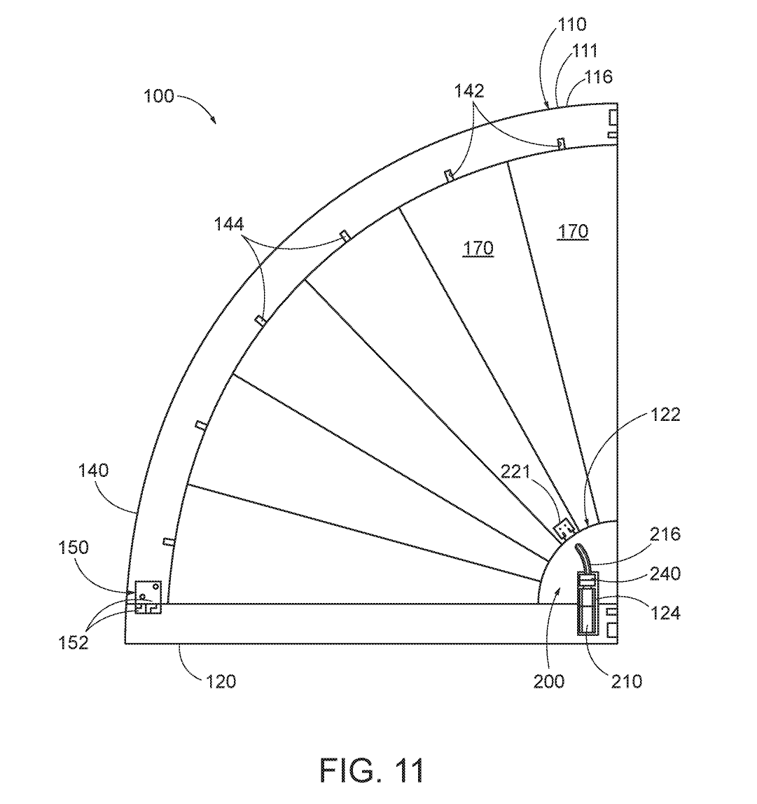

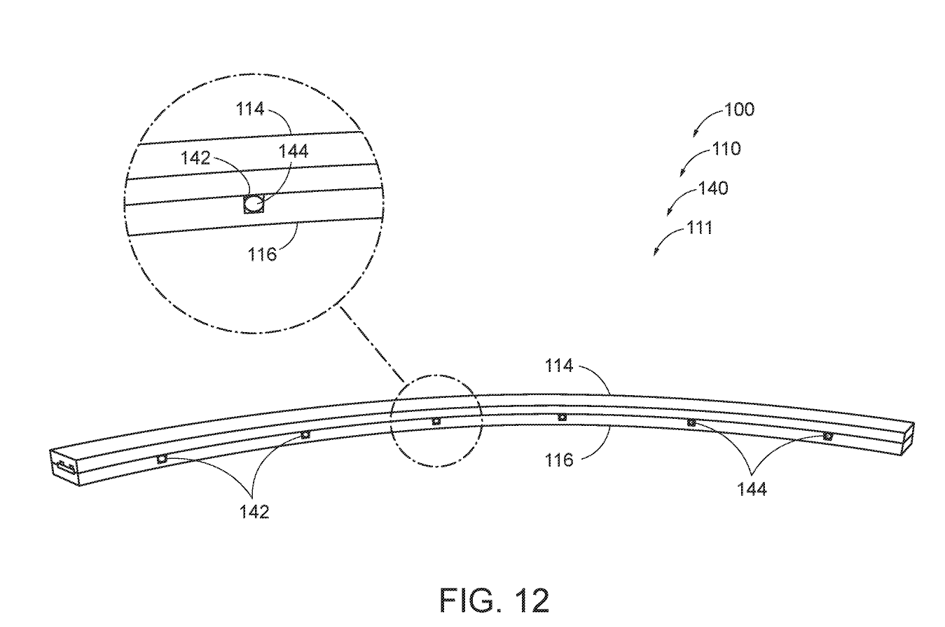

FIG. 11 illustrates a portion of shutter 100 that includes first drive mechanism 200. As illustrated in FIG. 11, motor 210 and/or motor compartment 124 may be oriented such that the rotary output of the motor corresponds to a rotation that is not coaxial with prime drive pin 221. In such a configuration, prime drive pin 221 may be operatively coupled to motor 210 via a flexible shaft 216. Flexible shaft 216 may include and/or be any appropriate material and/or construction for transmitting a rotary output of motor 210 to prime drive pin 221. As an example, flexible shaft 216 may be formed of a resiliently flexible material. Additionally or alternatively, in a configuration in which the rotary output of motor 210 corresponds to a rotation that is not coaxial with prime drive pin 221, the prime drive pin may be operatively coupled to the motor via any appropriate structure and/or mechanism for relaying the rotary output of the motor to the prime drive pin, examples of which may include a universal joint and/or a bevel gear linkage.

FIG. 12 illustrates an example of arch portion 140 of left frame side 111 of frame 110. As illustrated in FIG. 12, each arch recess 142 may be a groove defined in second frame layer 116 such that the groove takes the form of a bore when first frame layer 114 is placed adjacent to second frame layer 116. However, this construction is not required, and it is additionally within the scope of the present disclosure that each arch recess 142 may be a groove defined in one or more of first frame layer 114, second frame layer 116, and/or (when present) central frame layer 115.

FIG. 13 illustrates an example of right frame side 112 of shutter 100. Specifically, FIG. 13 illustrates a portion of an embodiment of shutter 100 that includes frame 110 with first frame layer 114 and second frame layer 116, and in which each arch recess 142 is a groove defined in the second frame layer. FIG. 13 further illustrates a configuration in which stile 134 extends from base portion 120 to arch portion 140.

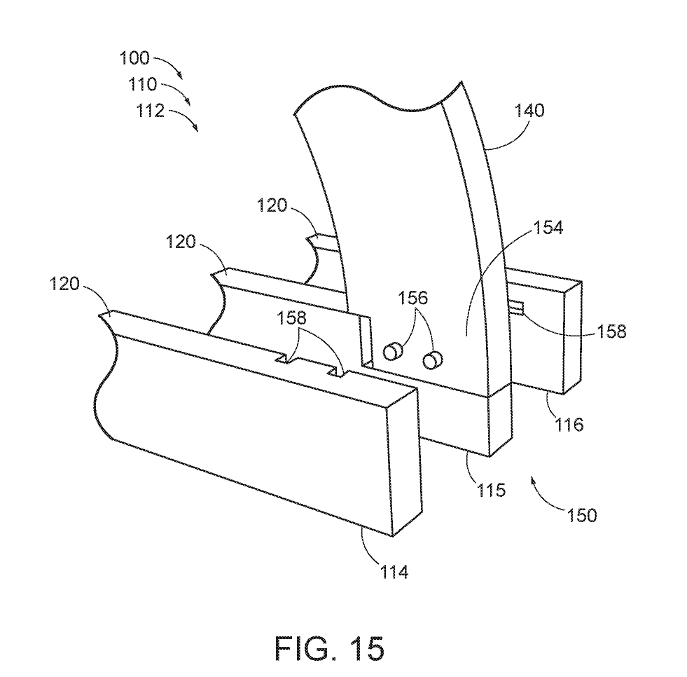

FIGS. 14-15 illustrate examples of frame joints 150 that may be utilized to couple base portion 120 to arch portion 140. Specifically, FIGS. 14-15 illustrate portions of embodiments of shutter 100 that includes frame joint 150 in the form of a mortise and tenon joint that includes a mortise 152 and a tenon 154. Mortise 152 may be at least partially defined by base portion 120, and tenon 154 may be configured to abut the mortise and/or be received in the mortise. In the embodiment of FIG. 14, frame 110 includes first frame layer 114 (not illustrated in FIG. 14) and second frame layer 116, and mortise 152 is defined in each of the first frame layer and the second frame layer of each of base portion 120 and arch portion 140. However, this is not required to all shutters 100, and it is additionally within the scope of the present disclosure that mortise 152 may be defined in any appropriate combination of first frame layer 114, second frame layer 116, and (when present) central frame layer 115. For example, mortise 152 may be defined in second frame layer 116 alone. In a configuration in which mortise 152 is a mortise recess that extends from base portion 120 to arch portion 140, the mortise may be configured to receive a separate tenon 154 that operatively interconnects the base portion and the arch portion.

In the embodiment of FIG. 15, frame 110 includes first frame layer 114, central frame layer 115, and second frame layer 116. In such an embodiment, frame joint 150 may include a mortise 152 (not shown in FIG. 15) that is defined by the central frame layer of base portion 120 and a tenon 154 that is defined by central frame layer 115 of arch portion 140, such that the mortise and tenon are configured to abut one another when base portion 120 is coupled to arch portion 140. However, this is not required to all shutters 100, and it is additionally within the scope of the present disclosure that mortise 152 and tenon 154 (when present) may be defined by any appropriate portions of frame 110. For example, mortise 152 may be defined by first frame layer 114 and/or second frame layer 116 of base portion 120, and/or tenon 154 may be defined by first frame layer 114 and/or second frame layer 116 of arch portion 140. Additionally or alternatively, mortise 152 may be at least partially defined by arch portion 140, and/or tenon 154 may be at least partially defined by base portion 120.

As illustrated in FIGS. 14-15, frame joint 150 also may include at least one dowel 156 that extends in a direction that is at least substantially perpendicular to shutter plane 106 and that is concealed from view when shutter 100 is assembled. Dowel 156 may extend through tenon 154 and/or may be incorporated into the tenon such that the tenon and the dowel are of unitary construction. Each dowel 156 may be configured to be received in a corresponding dowel groove 158 defined in base portion 120 of first frame layer 114 and/or second frame layer 116 when base portion 120 is coupled to arch portion 140. As a more specific example, frame joint 150, dowel 156, and/or dowel groove 158 may be configured such that base portion 120 and arch portion 140 may be selectively coupled to one another and selectively uncoupled from one another only when frame 110 is in the folded configuration. Such a configuration may restrict base portion 120 from being inadvertently uncoupled from arch portion 140 when frame 110 is in the unfolded configuration.

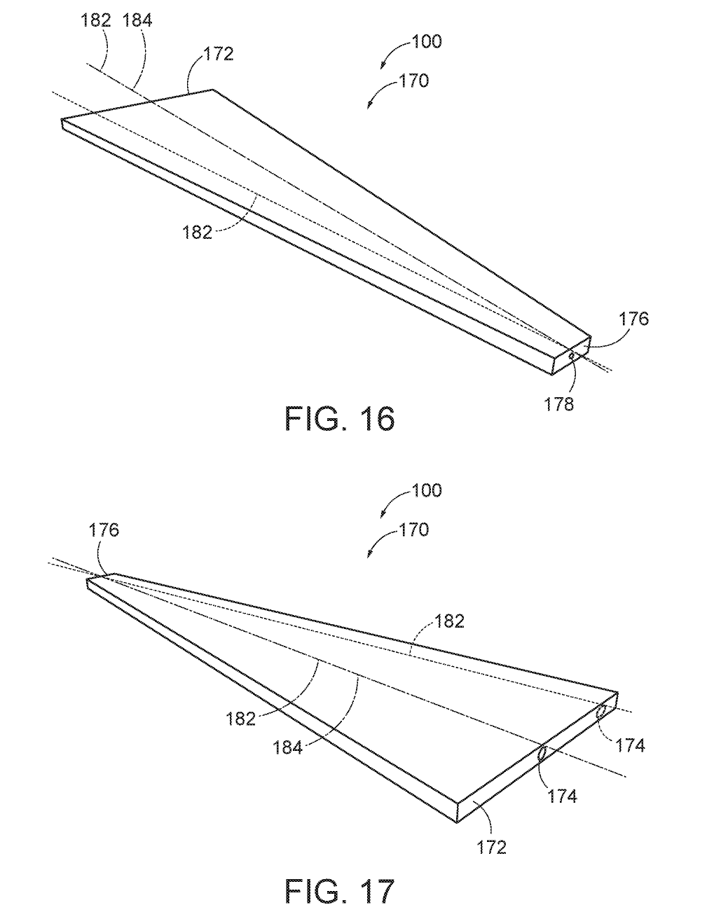

FIGS. 16-17 illustrate an example of louver 170 in each of the collinear axis embodiment and the non-parallel axis embodiment. In the collinear axis embodiment, and as illustrated in dash-dot lines in FIGS. 16-17, pivot axis 182 is at least substantially collinear with longitudinal axis 184. In such an embodiment, each louver 170 may be configured to rotate such that a proportion of the louver that moves toward first face 102 of shutter 100 is substantially equal to a proportion of the louver that moves toward second face 104. Stated differently, in the collinear axis embodiment, each louver 170 may be configured to rotate at least substantially symmetrically about pivot axis 182.

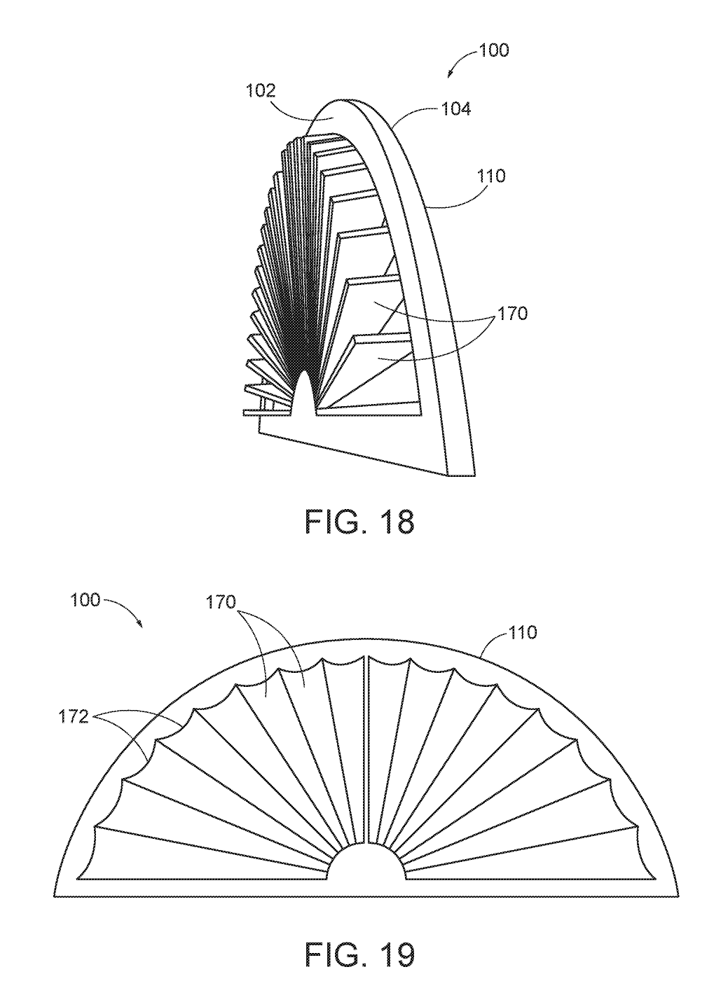

By contrast, in the non-parallel axis embodiment, and as illustrated in dashed lines in FIGS. 16-17, pivot axis 182 is distinct from longitudinal axis 184. In such an embodiment, each louver 170 may be configured to rotate such that a proportion of the louver that moves toward one of first face 102 and second face 104 is greater than a proportion of the louver that moves toward the other of the first face and the second face. Stated differently, in the non-parallel axis embodiment, each louver 170 may be configured to rotate asymmetrically about pivot axis 182. As an example, and as illustrated in FIG. 18, each louver 170 may be configured to rotate such that a greater proportion of the louver rotates toward first face 102 than toward second face 104. Such an embodiment may enable shutter 100 to be positioned adjacent to an object, such as a window, such that the plurality of louvers 170 may rotate without being restricted by and/or coming into contact with the object.

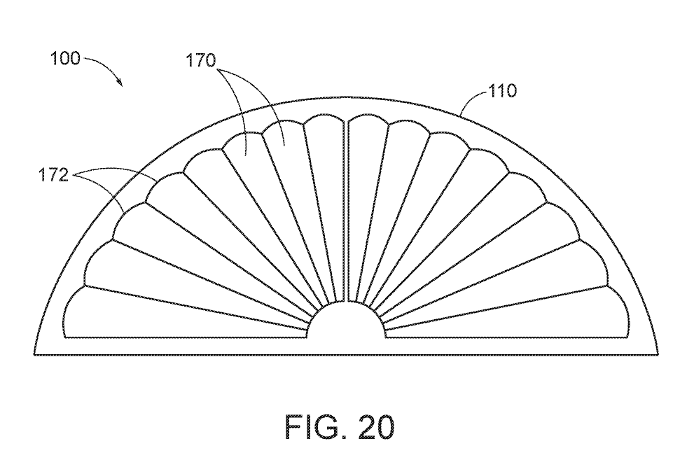

Each louver 170 may have any appropriate shape, such as to suit the user's aesthetic preferences and/or to conform to the shape and/or size of frame 110. As an example, and as illustrated in FIG. 19, each louver 170 may have a wide louver side 172 that has a concave shape. As another example, and as illustrated in FIG. 20, each louver 170 may have a wide louver side 172 that has a convex shape. These examples are not limiting or exclusive, however, and it is additionally within the scope of the present disclosure that any portion of louver 170 may have any appropriate shape and/or combination of shapes, and/or that shutter 100 may include louvers 170 that do not all share a common shape.

U.S. Provisional Patent Application Ser. No. 62/449,482, which was filed on Jan. 23, 2017 and which is incorporated by reference for all purposes, discloses additional examples of suitable shapes and configurations for shutters 100, frame 110, louvers 170, and other components of shutters 100 according to the present disclosure. This incorporated provisional patent application also discloses examples of methods of manufacturing and installing shutters 100 according to the present disclosure. For example, methods 800 of manufacturing a plantation window shutter (such as shutter 100) are disclosed on page 27, line 8-page 34, line 10 of the '482 application, and methods 900 of installing a plantation window shutter (such as shutter 100) are disclosed on page 34, line 11-page 37, line 16 of the '482 application.

As discussed in more detail in the '482 application, methods 800 of manufacturing a shutter 100 may, but are not required in all embodiments to, include providing a sheet of stock material, forming at least one shutter component from the sheet of stock material, and at least partially assembling the shutter from the at least one shutter component. The forming may include milling a shutter component with a computer numeric control (CNC) router, and methods 800 further may include determining a CNC routine and/or supplying a CNC routine to the CNC router.

As discussed in more detail in the '482 application, methods 900 of installing a plantation window shutter 100 may, but are not required in all embodiments to, include providing the shutter, providing an installation frame that includes at least one shutter-side magnetic material and at least one surface-side magnetic material, and coupling the shutter to the installation frame. Methods 900 further may include activating at least one adhesive marker of the surface-side magnetic material to expose an adhesive surface on the adhesive marker and preliminarily positioning the installation frame and the shutter on a vertical surface with an opening such that the at least one adhesive marker adheres to the vertical surface. The methods additionally may include affixing at least one surface-side magnetic material to the vertical surface at a location indicated by a corresponding adhesive marker and mounting the installation frame and the shutter to the vertical surfaces such that an attractive magnetic force between the shutter-side magnetic material and the surface-side magnetic material at least partially retains the shutter and the installation frame in position with respect to the opening.

Examples of shutters 100 according to the present disclosure are described in the following enumerated paragraphs:

A1. A plantation window shutter, the shutter comprising:
a frame that includes a base portion with a hub and an arch portion coupled to the base portion such that the base portion and the arch portion define a shutter plane; and
a plurality of louvers extending from the hub toward the arch portion;

wherein each louver of the plurality of louvers includes:
a wide louver side that is proximal the arch portion relative to the hub;
a hub louver side that is proximal the hub relative to the arch portion; and
a longitudinal axis that extends from a center of the wide louver side to a center of the hub louver side;

wherein the shutter has a first face and a second face opposite the first face, and wherein each louver of the plurality of louvers is configured to selectively transition between a closed orientation and an open orientation by rotating about a pivot axis that extends from the wide louver side to the hub louver side, and optionally that is at least substantially parallel to the longitudinal axis.

A2. The shutter of paragraph A1, wherein the frame includes a left frame side and a right frame side that is separate from the left frame side, and wherein the left frame side is pivotally coupled to the right frame side by at least one frame hinge, and optionally by at least two frame hinges.

A3. The shutter of paragraph A2, wherein each of the left frame side and the right frame side includes a first face that forms a portion of the first face of the shutter; wherein each of the left frame side and the right frame side includes a second face that forms a portion of the second face of the shutter; and wherein the at least one frame hinge is configured to transition the frame between a folded configuration, in which the first face of the left frame side faces the first face of the right frame side, and an unfolded configuration, in which the left frame side and the right frame side are generally coplanar.

A4. The shutter of any of paragraphs A1-A3, wherein the frame includes a first frame layer and a second frame layer opposite the first frame layer.

A5. The shutter of paragraph A4, wherein the frame further includes a central frame layer positioned between the first frame layer and the second frame layer.

A6. The shutter of any of paragraphs A4-A5, wherein each of the base portion and the arch portion includes the first frame layer, the second frame layer, and (when present) the central frame layer.

A7. The shutter of any of paragraphs A4-A6, wherein the first frame layer, the second frame layer, and the central frame layer (when present) are at least substantially identical in size and thickness.

A8. The shutter of any of paragraphs A1-A7, wherein the arch portion and the base portion are configured to be selectively coupled to one another via at least one frame joint.

A9. The shutter of any of paragraphs A1-A8, wherein the arch portion and the base portion are further configured to be selectively uncoupled from one another and recoupled to one another without damage to the arch portion or the base portion.

A10. The shutter of any of paragraphs A3-A9, when dependent from paragraph A3, wherein the arch portion and the base portion are configured to be at least one of selectively coupled to one another and selectively uncoupled from one another only when the frame is in the folded configuration.

A11. The shutter of any of paragraphs A8-A10, when dependent from paragraph A8, wherein the frame joint includes, and optionally is, a mortise and tenon joint that includes a mortise at least partially defined by the base portion and a tenon configured to at least one of abut the mortise and be received in the mortise.

A12. The shutter of paragraph A11, when dependent from paragraph A4, wherein the mortise is defined by the first frame layer of the base portion, and wherein the tenon is defined by the first frame layer of the arch portion.

A13. The shutter of any of paragraphs A11-A12, wherein the frame includes a/the central frame layer, wherein the mortise is defined by the central frame layer of the base portion, and wherein the tenon is defined by the central frame layer of the arch portion.

A14. The shutter of any of paragraphs A11-A13, when dependent from paragraph A4, wherein the mortise is a mortise recess defined in at least one of the first frame layer, the second frame layer, and (when present) the central frame layer, wherein the mortise recess is defined in each of the base portion and the arch portion, and wherein the tenon is a separate component that is received in the mortise recess.

A15. The shutter of any of paragraphs A8-A14, when dependent from paragraph A8, wherein the frame joint includes at least one dowel that extends in a direction that is at least substantially perpendicular to the shutter plane, and further wherein the at least one dowel is concealed from view when the shutter is assembled.

A16. The shutter of paragraph A15, wherein the at least one dowel extends through a/the tenon of a/the mortise and tenon joint.

A17. The shutter of any of paragraphs A15-A16, when dependent from paragraph A4, wherein the base portion of at least one of the first frame layer and the second frame layer includes at least one dowel groove configured to receive the at least one dowel when the arch portion is coupled to the base portion.

A18. The shutter of any of paragraphs A1-A17, wherein each louver of the plurality of louvers is coupled to the hub via a corresponding drive pin of a plurality of drive pins.

A19. The shutter of paragraph A18, wherein each drive pin of the plurality of drive pins is received in a corresponding hub-side louver bore defined in the hub louver side.

A20. The shutter of paragraph A19, wherein each drive pin of the plurality of drive pins is generally cylindrical.

A21. The shutter of any of paragraphs A19-A20, wherein each drive pin of the plurality of drive pins includes a louver engagement cradle configured to engage an exterior surface of the corresponding louver to transmit a torque to the corresponding louver.

A22. The shutter of any of paragraphs A19-A21, wherein each drive pin of the plurality of drive pins includes a collar extending circumferentially around the drive pin, wherein the collar is configured to engage the hub to at least partially restrict motion of the drive pin with respect to the hub in a direction generally parallel to the pivot axis.

A23. The shutter of any of paragraphs A1-A22, wherein each louver of the plurality of louvers includes a louver magnetic material, wherein the arch portion includes a plurality of arch magnetic materials, and wherein each louver of the plurality of louvers is operatively coupled to the arch portion via a magnetic coupling between a respective louver magnetic material and a corresponding arch magnetic material.

A24. The shutter of paragraph A23, wherein each louver magnetic material is positioned in an arch-side louver bore defined in the wide louver side of the corresponding louver.

A25. The shutter of any of paragraphs A23-A24, wherein each arch magnetic material is positioned in a corresponding arch recess of a plurality of arch recesses defined in the arch portion.

A26. The shutter of paragraph A25, when dependent from paragraph A24, wherein the louver magnetic material and the arch magnetic material are configured such that the louver magnetic material does not rotate with respect to the corresponding louver and the arch magnetic material does not rotate with respect to the corresponding arch recess when the louver rotates with respect to the frame.

A27. The shutter of any of paragraphs A25-A26, wherein one of the louver magnetic material and the arch magnetic material includes a magnet, and wherein the other of the louver magnetic material and the arch magnetic material includes at least one of a magnet and a ferromagnetic material.

A28. The shutter of any of paragraphs A25-A27, when dependent from paragraph A4, wherein each arch recess of the plurality of arch recesses is a groove defined in at least one of the first frame layer of the arch portion, the second frame layer of the arch portion, and (when present) a/the central frame layer of the arch portion.

A29. The shutter of any of paragraphs A1-A28, wherein the pivot axis of each louver of the plurality of louvers is spaced apart from the longitudinal axis of the louver.

A30. The shutter of any of paragraphs A1-A29, wherein the pivot axis of each louver of the plurality of louvers intersects the longitudinal axis of the louver at exactly one point.

A31. The shutter of any of paragraphs A1-A30, wherein each louver of the plurality of louvers is configured to rotate such that a proportion of the louver that moves toward one of the first face and the second face of the shutter is greater than a proportion of the louver that moves toward the other of the first face and the second face.

A32. The shutter of any of paragraphs A1-A28, wherein the pivot axis of each louver of the plurality of louvers is at least substantially collinear with the longitudinal axis of the louver.

A33. The shutter of any of paragraphs A1-A28 or A32, wherein each louver of the plurality of louvers is configured to rotate such that a proportion of the louver that moves toward one of the first face and the second face of the shutter is substantially equal to a proportion of the louver that moves toward the other of the first face and the second face.

A34. The shutter of any of paragraphs A1-A33, wherein the shutter includes a drive mechanism at least substantially enclosed in the hub and configured to actuate the plurality of louvers between the open orientation and the closed orientation, wherein the drive mechanism includes a motor operatively coupled to each louver of the plurality of louvers via a/the corresponding drive pin of a/the plurality of drive pins to pivot each louver of the plurality of louvers about the respective pivot axis.

A35. The shutter of paragraph A34, wherein the drive mechanism includes a flexible shaft that operatively connects the motor to at least one of the plurality of drive pins.

A36. The shutter of paragraph A35, wherein the flexible shaft includes at least one of a resiliently flexible material and a universal joint.

A37. The shutter of any of paragraphs A34-A36, wherein the drive mechanism includes a plurality of chains, wherein each chain of the plurality of chains includes a plurality of chain post attachment points separated by a plurality of linkages.

A38. The shutter of paragraph A37, wherein the plurality of chains includes a first chain and a second chain, and optionally wherein the plurality of chains further includes a third chain and a fourth chain.

A39. The shutter of any of paragraphs A37-A38, wherein at least one chain of the plurality of chains is a flexible chain.

A40. The shutter of paragraph A39, wherein at least one chain of the plurality of chains is a resiliently flexible chain.

A41. The shutter of any of paragraphs A37-A40, wherein at least one chain of the plurality of chains is a non-rigid chain.

A42. The shutter of any of paragraphs A37-A41, wherein each drive pin of the plurality of drive pins includes a plurality of chain posts, wherein each chain of the plurality of chains engages a corresponding chain post of the plurality of chain posts at a respective chain post attachment point.

A43. The shutter of any of paragraphs A37-A42, wherein the plurality of chains are configured in a pull-pull configuration in which each drive pin of the plurality of drive pins receives a tension force on at least one of the corresponding chain post attachment points when the motor is operated.

A44. The shutter of any of paragraphs A37-A43, wherein the plurality of chains are not configured in either of a push-pull configuration and a push-push configuration.

A45. The shutter of any of paragraphs A37-A44, wherein the plurality of drive pins includes a prime drive pin, wherein the prime drive pin is operatively coupled to the motor via a motor coupling, wherein the prime drive pin is operatively coupled to a remainder of the plurality of drive pins via at least one chain of the plurality of chains, and wherein the prime drive pin is configured to receive a rotary force from the motor and to relay the rotary force to the remainder of the plurality of drive pins via the at least one chain of the plurality of chains.

A46. The shutter of paragraph A45, wherein the prime drive pin includes a motor engagement structure configured to matingly engage at least a portion of the motor coupling.

A47. The shutter of any of paragraphs A45-A46, wherein the motor coupling includes a magnetic clutch that includes a motor-side magnetic material and a pin-side magnetic material, wherein the magnetic clutch is configured to transmit an applied torque from the motor-side magnetic material to the pin-side magnetic material at least partially via a magnetic force therebetween when the applied torque is less than a threshold torque, and wherein the magnetic clutch is configured such that the motor-side magnetic material and the pin-side magnetic material may rotate with respect to one another when the applied torque is greater than the threshold torque.

A48. The shutter of paragraph A47, wherein one of the motor-side magnetic material and the pin-side magnetic material includes a magnet, and wherein the other of the motor-side magnetic material and the pin-side magnetic material includes at least one of a magnet and a ferromagnetic material.

A49. The shutter of any of paragraphs A47-A48, wherein the pin-side magnetic material is coupled to the prime drive pin such that the pin-side magnetic material and the prime drive pin are configured to rotate in unison.

A50. The shutter of any of paragraphs A34-A49, wherein the drive mechanism further includes a motor controller configured to at least partially control a rotary output of the motor.

A51. The shutter of any of paragraphs A34-A50, wherein the drive mechanism further includes a motor switch configured to be actuated by a user to at least partially selectively control a/the rotary output of the motor.

A52. The shutter of paragraph A51, wherein the motor switch is configured to operate in conjunction with a/the motor controller to selectively control the rotary output of the motor.

A53. The shutter of any of paragraphs A34-A52, wherein the drive mechanism further includes a motor power supply configured to supply electric power to the motor, wherein the motor power supply includes at least one of a motor battery, a solar powered motor battery, a solar panel, a photodetector, a motor power adapter, a motor power cord, and a motor power cord socket.

A54. The shutter of paragraph A53, wherein the motor power supply includes the solar powered motor battery and further wherein the solar powered motor battery supplies electric power to the motor and receives electrical charge from the solar panel.

A55. The shutter of any of paragraphs A53-A54, wherein the motor power supply is configured to supply electric power to the motor when the photodetector senses a light level that is at least one of less than a threshold light level and greater than the threshold light level.

A56. The shutter of any of paragraphs A34-A55, when dependent from paragraph A2, wherein the drive mechanism is a first drive mechanism, wherein the first drive mechanism is enclosed within the hub of the left frame side, wherein the first drive mechanism is configured to actuate a first plurality of louvers between the open orientation and the closed orientation, and wherein the shutter further includes a second drive mechanism enclosed within the hub of the right frame side, wherein the second drive mechanism is configured to actuate a second plurality of louvers between the open orientation and the closed orientation.

A57. The shutter of paragraph A56, wherein the motor of the first drive mechanism is a first motor, and wherein the second drive mechanism includes a second motor.

A58. The shutter of paragraph A57, wherein the first motor and the second motor are configured to actuate the corresponding pluralities of louvers at least substantially in unison.

A59. The shutter of any of paragraphs A57-A58, wherein the first motor and the second motor are electrically connected via at least one electrical contact such that the first motor and the second motor operate at least substantially in unison.

A60. The shutter of paragraph A59, wherein the at least one electrical contact is configured to complete an electrical circuit when the frame is in an/the unfolded configuration, and wherein the at least one electrical contact is configured to break the electrical circuit at least when the frame is in a/the folded configuration.

A61. The shutter of any of paragraphs A1-A60, when dependent from paragraph A4, wherein the hub includes a motor compartment configured to enclose the motor, wherein the motor compartment is defined in at least one of the first frame layer, the second frame layer, and (when present) a/the central frame layer.

A62. The shutter of paragraph A61, wherein the motor compartment extends from the first frame layer to the second frame layer.

A63. The shutter of any of paragraphs A1-A62, when dependent from paragraph A4, wherein the hub includes an electronics compartment configured to enclose at least one of a/the motor controller, a/the motor power supply, a/the motor battery, a/the motor power adapter, and a/the motor power cord socket, wherein the electronics compartment is defined in at least one of the first frame layer, a/the central frame layer (when present), and the second frame layer.

A64. The shutter of paragraph A63, wherein the electronics compartment extends from the first frame layer to the second frame layer.

A65. The shutter of any of paragraphs A63-A64, when dependent from paragraph A61, wherein the electronics compartment is connected to the motor compartment.

A66. The shutter of any of paragraphs A1-A65, wherein the hub includes a hinge pocket configured to receive a/the frame hinge.

A67. The shutter of any of paragraphs A1-A66, wherein the shutter further includes a stile configured to overlay a central portion of the shutter, and where the frame includes at least one stile magnet configured to retain the stile in position.

A68. The shutter of any of paragraphs A18-A67, when dependent from paragraph A18, wherein the plurality of drive pins is configured to be received in a corresponding plurality of pin indentations defined by the hub, wherein each pin indentation of the plurality of pin indentations extends in a direction at least substantially parallel to the pivot axis of the louver coupled to the drive pin received in the pin indentation, and wherein each pin indentation of the plurality of pin indentations is configured to permit the drive pin received in the pin indentation to rotate about the corresponding pivot axis.

A69. The shutter of paragraph A68, wherein each pin indentation of the plurality of pin indentations defines an orientation of the pivot axis of the louver associated with the drive pin that is received in the pin indentation.

A70. The shutter of any of paragraphs A68-A69, when dependent from paragraph A4, wherein the plurality of pin indentations is defined in at least one of the first frame layer, the second frame layer, and (when present) a/the central frame layer.

A71. The shutter of any of paragraphs A68-A70, when dependent from paragraph A4, wherein each indentation of the plurality of pin indentations is a pin bore defined in one of the first frame layer, the second frame layer, and (when present) the central frame layer.

A72. The shutter of any of paragraphs A68-A70, when dependent from paragraph A4, wherein each indentation of the plurality of pin indentations is a pin groove defined on an exterior face of at least one of the first frame layer, the second frame layer, and (when present) the central frame layer.

A73. The shutter of any of paragraphs A18-A72, when dependent from paragraph A18, wherein each drive pin of the plurality of drive pins is configured to be received in a corresponding drive pin bushing of a plurality of drive pin bushings, wherein each drive pin bushing of the plurality of drive pin bushings is configured to permit the corresponding drive pin to rotate therein about the corresponding pivot axis, and wherein each drive pin bushing of the plurality of drive pin bushings is fixedly coupled to the hub to substantially define an/the orientation of the corresponding pivot axis with respect to the hub.

A74. The shutter of paragraph A73, wherein each drive pin bushing of the plurality of drive pin bushings is configured to be received in a corresponding bushing retention structure defined in the hub.

A75. The shutter of any of paragraphs A1-A74, wherein the wide louver side of each louver of the plurality of louvers has a convex shape.

A76. The shutter of any of paragraphs A1-A75, wherein the wide louver side of each louver of the plurality of louvers has a concave shape.

A77. The shutter of any of paragraphs A1-A76, wherein the frame has a shape that is at least one of semicircular, elliptical, oval, circular, quarter-circular, triangular, wedge-shaped, and/or a polygon.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, “at least substantially,” when modifying a degree or relationship, includes not only the recited “substantial” degree or relationship, but also the full extent of the recited degree or relationship. For example, an object that is at least substantially parallel to a second object includes objects that are substantially parallel to the second object and also includes objects that are parallel to the second object.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. An adjustable plantation shutter, the shutter comprising:
a frame that includes a base portion with a hub and an arch portion coupled to the base portion such that the base portion and the arch portion define a shutter plane; and
a plurality of louvers extending from the hub toward the arch portion;
wherein each louver of the plurality of louvers includes:
a wide louver side that is proximal the arch portion relative to the hub;
a hub louver side that is proximal the hub relative to the arch portion; and
a longitudinal axis that extends from the wide louver side to the hub louver side;
wherein the shutter has a first face and a second face opposite the first face; wherein each louver of the plurality of louvers is configured to selectively transition between a closed orientation and an open orientation by rotating about a pivot axis that extends from the wide louver side to the hub louver side; wherein each louver of the plurality of louvers includes a louver magnetic material; wherein the arch portion includes a plurality of arch magnetic materials; and wherein each louver of the plurality of louvers is operatively coupled to the arch portion via a magnetic coupling between a respective louver magnetic material and a corresponding arch magnetic material.

2. The shutter of claim 1, wherein each louver magnetic material is positioned in an arch-side louver bore defined in the wide louver side of the corresponding louver.

3. The shutter of claim 1, wherein each arch magnetic material is positioned in a corresponding arch recess of a plurality of arch recesses defined in the arch portion.

4. The shutter of claim 3, wherein the louver magnetic material and the arch magnetic material are configured such that the louver magnetic material does not rotate with respect to the corresponding louver and the arch magnetic material does not rotate with respect to the corresponding arch recess when the louver rotates with respect to the frame.

5. The shutter of claim 3, wherein the frame includes a first frame layer and a second frame layer opposite the first frame layer, and wherein each arch recess of the plurality of arch recesses is a groove defined in at least one of the first frame layer of the arch portion and the second frame layer of the arch portion.

6. The shutter of claim 3, wherein the frame includes a first frame layer, a second frame layer opposite the first frame layer, and a central frame layer positioned between the first frame layer and the second frame layer, and wherein each arch recess of the plurality of arch recesses is a groove defined in at least one of the first frame layer of the arch portion, the second frame layer of the arch portion, and the central frame layer of the arch portion.

7. The shutter of claim 1, wherein the frame includes a left frame side and a right frame side that is separate from the left frame side; wherein the left frame side is pivotally coupled to the right frame side by at least one frame hinge; wherein each of the left frame side and the right frame side includes a first face that forms a portion of the first face of the shutter; wherein each of the left frame side and the right frame side includes a second face that forms a portion of the second face of the shutter; and wherein the at least one frame hinge is configured to transition the frame between a folded configuration, in which the first face of the left frame side faces the first face of the right frame side, and an unfolded configuration, in which the left frame side and the right frame side are generally coplanar.

8. The shutter of claim 7, wherein the arch portion and the base portion are configured to be selectively uncoupled from one another and recoupled to one another without damage to the arch portion or the base portion only when the frame is in the folded configuration.

9. The shutter of claim 1, wherein the pivot axis of each louver of the plurality of louvers is spaced apart from the longitudinal axis of the louver.

10. The shutter of claim 1, wherein each louver of the plurality of louvers is configured to rotate such that a proportion of the louver that moves toward one of the first face and the second face of the shutter is greater than a proportion of the louver that moves toward the other of the first face and the second face.

11. An adjustable plantation shutter, the shutter comprising:
a frame that includes a base portion with a hub and an arch portion coupled to the base portion such that the base portion and the arch portion define a shutter plane; and
a plurality of louvers extending from the hub toward the arch portion;
wherein each louver of the plurality of louvers includes:
a wide louver side that is proximal the arch portion relative to the hub;
a hub louver side that is proximal the hub relative to the arch portion; and
a longitudinal axis that extends from the wide louver side to the hub louver side;
wherein the shutter has a first face and a second face opposite the first face; wherein each louver of the plurality of louvers is configured to selectively transition between a closed orientation and an open orientation by rotating about a pivot axis that extends from the wide louver side to the hub louver side; wherein each louver of the plurality of louvers is coupled to the hub via a corresponding drive pin of a plurality of drive pins; wherein the shutter further includes a drive mechanism at least substantially enclosed in the hub and configured to actuate the plurality of louvers between the open orientation and the closed orientation; and wherein the drive mechanism includes a motor operatively coupled to each louver of the plurality of louvers via the corresponding drive pin of the plurality of drive pins to pivot each louver of the plurality of louvers about the respective pivot axis.

12. The shutter of claim 11, wherein each drive pin of the plurality of drive pins is received in a corresponding hub-side louver bore defined in the hub louver side of the corresponding louver.

13. The shutter of claim 11, wherein each drive pin of the plurality of drive pins includes a louver engagement cradle configured to engage an exterior surface of the corresponding louver to transmit a torque to the corresponding louver.

14. The shutter of claim 11, wherein the drive mechanism includes a plurality of chains; wherein each chain of the plurality of chains includes a plurality of chain post attachment points separated by a plurality of linkages; wherein each drive pin of the plurality of drive pins includes a plurality of chain posts; and wherein each chain of the plurality of chains engages a corresponding chain post of the plurality of chain posts at a respective chain post attachment point.

15. The shutter of claim 14, wherein at least one chain of the plurality of chains is a flexible chain.

16. The shutter of claim 15, wherein the plurality of chains are configured in a pull-pull configuration in which each drive pin of the plurality of drive pins receives a tension force on at least one of the corresponding chain post attachment points when the motor is operated.

17. The shutter of claim 11, wherein the frame includes a left frame side and a separate right frame side; wherein the left frame side is pivotally coupled to the right frame side by at least one frame hinge; wherein the drive mechanism is a first drive mechanism; wherein the first drive mechanism is enclosed within the hub of the left frame side; wherein the first drive mechanism is configured to actuate a first plurality of louvers between the open orientation and the closed orientation; and wherein the shutter further includes a second drive mechanism enclosed within the hub of the right frame side; wherein the second drive mechanism is configured to actuate a second plurality of louvers between the open orientation and the closed orientation.

18. The shutter of claim 17, wherein the motor of the first drive mechanism is a first motor; wherein the second drive mechanism includes a second motor; and wherein the first motor and the second motor are electrically connected via at least one electrical contact such that the first motor and the second motor operate at least substantially in unison.

19. The shutter of claim 11, wherein the plurality of drive pins is configured to be received in a corresponding plurality of pin indentations defined by the hub, wherein each pin indentation of the plurality of pin indentations extends in a direction at least substantially parallel to the pivot axis of the louver coupled to the drive pin received in the pin indentation, and wherein each pin indentation of the plurality of pin indentations is configured to permit the drive pin received in the pin indentation to rotate about the corresponding pivot axis.

20. The shutter of claim 11, wherein each drive pin of the plurality of drive pins is configured to be received in a corresponding drive pin bushing of a plurality of drive pin bushings, wherein each drive pin bushing of the plurality of drive pin bushings is configured to permit the corresponding drive pin to rotate therein about the corresponding pivot axis, and wherein each drive pin bushing of the plurality of drive pin bushings is fixedly coupled to the hub to substantially define an orientation of the corresponding pivot axis with respect to the hub.

21. The shutter of claim 11, wherein the pivot axis of each louver of the plurality of louvers is spaced apart from the longitudinal axis of the louver.

22. The shutter of claim 11, wherein each louver of the plurality of louvers is configured to rotate such that a proportion of the louver that moves toward one of the first face and the second face of the shutter is greater than a proportion of the louver that moves toward the other of the first face and the second face.
